(19) United States
(12) Patent Application Publication
(10) Pub. No.: US 2026/0079125 A1
(43) Pub. Date: Mar. 19, 2026

(54) DEVICE FOR QUANTIFYING ANALYTES IN LIQUID SAMPLES

(71) Applicant: TESLA DIAGNOSTIX LTD, Bristol (GB)

(72) Inventor: Despina Moschou, Bristol (GB)

(73) Assignee: TESLA DIAGNOSTIX LTD, Bristol (GB)

(21) Appl. No.: 19/110,801

(22) PCT Filed: Sep. 13, 2023
(86) PCT No.: PCT/GB2023/052368

§ 371 Date: Mar. 11, 2025

(30) Foreign Application Priority Data
Sep. 13, 2022 (GR) 20220100744
Nov. 17, 2022 (GB) 2217199.5

(51) Int. Cl. G01N 27/333; G01N 27/30; G01N 27/327

(52) U.S. Cl. CPC G01N 27/333; G01N 27/301; G01N 27/307; G01N 27/3272

(57) ABSTRACT

An electrochemical sensing device for quantifying an analyte in a liquid sample includes a substrate, a plurality of electrodes disposed on the substrate, one of the plurality of electrodes being functionalised with a catalyst, the catalyst comprising an inorganic compound, and a hydrophilic channel disposed on the substrate configured to receive the liquid sample and direct the liquid sample to the electrodes.

### CROSS REFERENCE TO RELATED APPLICATIONS

The present application claims the priority benefits of International Patent Application No. PCT/GB2023/052368, filed on Sep. 13, 2023, and claims benefit of GB 20220100744, filed on Sep. 13, 2022, and GB 2217199.5, filed on Nov. 17, 2022, which are hereby incorporated herein by reference in their entireties.

### FIELD OF THE INVENTION

The present invention relates to devices for quantifying analytes in liquid samples.

### BACKGROUND OF THE INVENTION

Enzymatic electrochemical sensors have been one of the most commercially successful biosensing technologies for quantifying analytes in liquid samples. In particular, the technologies have been adopted broadly in home blood glucose test strips for monitoring diabetic patients'chronic condition. This example demonstrates the potential of the utility of electrochemical assays in quickly and accurately quantifying analytes that are amenable to enzymatic reactions. However, enzymes that are used as catalysts in conventional enzymatic electrochemical sensors exhibit low stability over environmental conditions and, more significantly, have limited sensitivity in low-abundance molecule quantification. An example is the quantification of glucose in human saliva-the much lower concentration of glucose in saliva compared, e.g., to blood cannot be accurately quantified using existing enzymatic electrochemical biosensor technology. If saliva can be used to accurately quantify glucose level in a human subject, it would enable a non-invasive means for managing diabetic conditions in human patients.

It is therefore desirable to improve the reliability and sensitivity of devices for quantifying analytes in liquid samples.

### SUMMARY OF THE INVENTION

In view of the foregoing, an aspect of the present invention provides an electrochemical sensing device for quantifying an analyte in a liquid sample, comprising: a substrate; a plurality of electrodes disposed on the substrate, one of the plurality of electrodes being functionalised with a catalyst, the catalyst comprising an inorganic compound; and a hydrophilic channel disposed on the substrate configured to receive the liquid sample and direct the liquid sample to the electrodes.

According to embodiments of the present invention, an electrochemical sensing device is provided for quantifying an analyte, such as glucose, in a liquid sample, such as blood or saliva. In use, the liquid sample is deposited on the hydrophilic channel, for example at a dedicated sample inlet or window that exposes the hydrophilic channel. The liquid sample is then carried along the hydrophilic channel towards the plurality of electrodes, where measurements can take place. One of the plurality of electrodes is provided with and functionalised by an inorganic catalyst, which reacts with the analyte in the liquid sample to enable a concentration or amount of the analyte to be determined. Compared to conventional enzymatic catalysts, inorganic catalysts exhibit higher stability over environmental conditions and, more importantly, have higher sensitivity to low concentration of analyte. Through the use of an inorganic catalyst, analyte quantification at low concentration, such as glucose in saliva, is made possible, and the resulting sensing device has improved stability.

In respect of glucose quantification, copper oxide as an inorganic alternative has shown high sensitivity in lower concentrations with high specificity compared to glucose oxidase enzyme. Thus, in some embodiments, the inorganic compound may comprise copper oxide. In other embodiments, the inorganic compound may comprise other metal oxides such as cobalt oxide, nickel oxide, iron oxide, or zinc oxide.

For some inorganic catalysts, their potential for high performance is dependent on the acidity and basicity (pH) of the solution with which they react. For example, copper oxide has shown outstanding performance in glucose quantification, but there is a technical requirement for the local pH of the solution to be within a specific range in the vicinity of the functionalised electrode on which the catalyst is deposited. Whilst blood serum pH is generally stable at around the physiological range (″7.4), saliva pH can vary greatly from person to person as well as at different time of the same day for the same person, depending or food or drink intake or oral health. As such, a straightforward replacement of an enzymatic catalyst with an inorganic catalyst on a simple screen-printed electrode strip such as the ones used in existing enzymatic electrochemical glucometers may be insufficient in some cases. Thus, in some embodiments, the device may further comprise a pH control system disposed adjacent the plurality of electrodes configured to control an acidity/basicity of at least a region around the functionalised electrode. In doing so, it is possible to control the acidity and/or basicity locally around the functionalised electrode to enable the use of catalysts that may be sensitive to variations in pH.

In some embodiments, the plurality of electrodes may comprise at least a working electrode, a counter electrode and a reference electrode, and wherein the pH control system may be disposed adjacent the working electrode.

In some embodiments, the pH control system may comprise a set of pH control electrodes.

In some embodiments, the set of pH control electrodes may comprise a pH sensing electrode and an active pH control electrode.

There are many different suitable forms which the pH sensing electrode may take. In some embodiments, the pH sensing electrode may comprise an ion selective sensing device or an ion-sensitive extended gate electrode arranged to enable an electronic reading of a pH value to be measured.

Similarly, there are many different suitable forms which the active pH control electrode may take. In some embodiments, the active pH control electrode may comprise a quinone-functionalized electrode configured to electrochemically induce electrons or protons around at least the functionalised electrode. In other embodiments, the active pH control electrode may be configured to function as a controlled release valve for an alkaline source stored on the device.

In some embodiments, the pH control system may be configured to communicate with and controlled by an electronic reader implementing a predetermined pH calibration algorithm.

In some embodiments, each of the plurality of electrodes may extend into an electrical connection pad configured to interface with an electronic reader.

In some embodiments, the plurality of electrodes may comprise at least a working electrode, a counter electrode and a reference electrode, wherein the plurality of electrodes may be arranged such that, upon applying an electrical potential between the working electrode and the reference electrode, a current is measured via the counter electrode.

In some embodiments, the functionalised electrode may be the working electrode and the catalyst may be deposited thereon.

The hydrophilic channel may take many different suitable forms as desired. In some embodiments, the hydrophilic channel may be formed of paper. In other embodiments, the hydrophilic channel may be formed by photolithography in a dry film photoresist.

In some embodiments, the hydrophilic channel may be formed with a surface micropattern configured to facilitate diffusion of the liquid sample, for example, following either a chemical or plasma-induced hydrophilization treatment.

In some embodiments, the substrate may comprise a printed circuit board. The printed circuit board having disposed thereon the plurality of electrodes and the hydrophilic channel, and optionally the pH control system, may in some embodiments be encased in a housing (e.g. a plastic housing) to protect the various elements of the electrochemical sensing device. An opening or window may be formed in the housing to allow access to a portion of the hydrophilic channel to enable the hydrophilic channel to receive a liquid sample. A second opening or window may be formed in the housing to allow access to the plurality of electrodes (and optionally the pH control system) to enable interfacing with e.g. an electronic reader.

Implementations of the present invewntion each have at least one of the above-mentioned objects and/or aspects, but do not necessarily have all of them. It should be understood that some aspects of the present invention that have resulted from attempting to attain the above-mentioned object may not satisfy this object and/or may satisfy other objects not specifically recited herein.

These and other objects, advantages and features of the invention will become apparent upon review of the following specification in conjunction with the drawings.

### BRIEF DESCRIPTION OF THE DRAWINGS

Embodiments will now be described, with reference to the accompanying drawings, in which:

FIG. 1 shows an exemplary electrochemical sensing device according to an embodiment of the present invention;

FIG. 2 shows another exemplary electrochemical sensing device;

FIG. 3 shows schematically an implementation of a pH control system; and

FIGS. 4A and 4B show the effect of liquid sample pH on the resulting measurements between two analytes.

### DESCRIPTION OF THE PREFERRED EMBODIMENTS

Inventors of the present invention recognized that enzymes that are used as catalysts in conventional enzymatic electrochemical sensors exhibit low stability over environmental conditions and, more significantly, have limited sensitivity in low-abundance molecule quantification.

The present approach replaces the organic enzymatic catalyst (e.g. glucose oxidase for the case of glucose) in conventional enzymatic electrochemical sensors with inorganic catalysts (e.g. copper oxide) that are sensitive to lower concentration of analyte and comparable selectivity towards the target analyte when appropriately engineered and operated. The present approach is therefore able to provide a device/system that is able to quantify analytes amenable to enzymatic assays in a sensitivity range much lower than conventionally possible.

Embodiments of the present invention provide an improved electrochemical sensing device for quantifying an analyte, such as glucose, in a liquid sample, such as blood or saliva. Embodiments of the device comprises a substrate, a plurality of electrodes disposed on the substrate including a functionalised electrode by an inorganic catalyst, and a hydrophilic channel disposed on the substrate for receiving the liquid sample and direct the liquid sample to the electrodes.

In use, the liquid sample is deposited on the hydrophilic channel, for example at a sample inlet that exposes the hydrophilic channel. The liquid sample is then carried along the hydrophilic channel towards the plurality of electrodes, where measurements can be taken. One of the plurality of electrodes is functionalised by an inorganic catalyst, which reacts with the analyte in the liquid sample to enable quantification of the analyte. Compared to conventional enzymatic catalysts, inorganic catalysts exhibit higher stability over environmental conditions and have greater sensitivity to low concentration of analyte. Through the use of an inorganic catalyst, analyte quantification at low concentration can be made possible, and the resulting sensing device has improved stability.

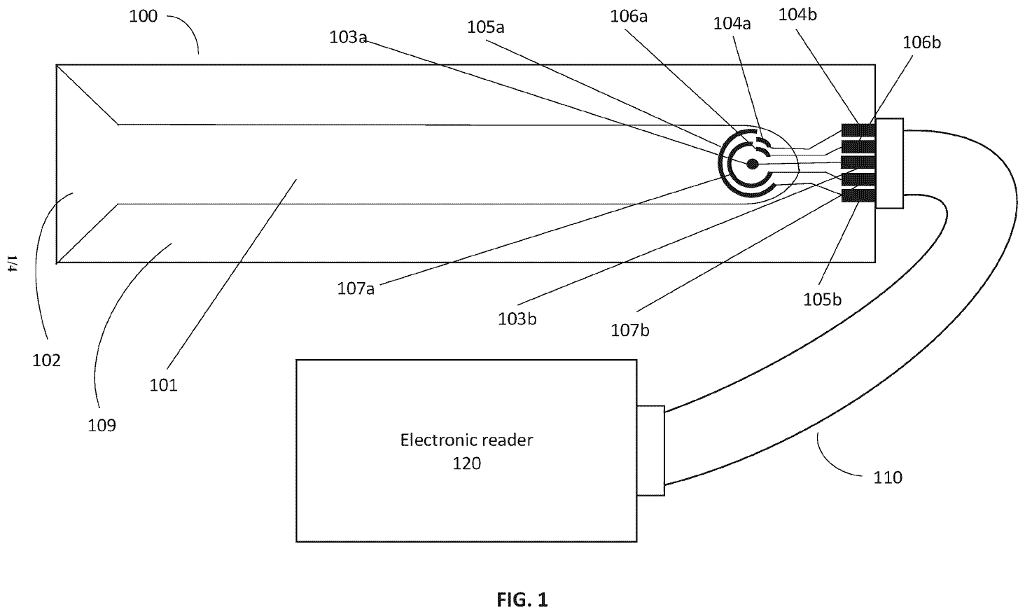

FIG. 1 shows an exemplary electrochemical sensing device 100 according to an embodiment of the present invention. The device 100 comprises a substrate 109 on which elements of the device 100 are disposed. The substrate 109 may be formed of any suitable material as desired, and in one embodiment, the substrate 109 may comprise a printed circuit board (PCB), and in another embodiment, the substrate 109 may be a base (e.g. of plastic) for screenprinted strips (e.g. for glucose quantification). In the present embodiment, the device 100 is implemented through flexible lab-on-PCB technology.

The device 100 comprises a hydrophilic channel 101 disposed on the substrate 109, the hydrophilic channel 101 having an inlet 102 towards one end for receiving a liquid sample and a sensing area towards an end opposite to the inlet 102. In the present embodiment, the inlet 102 is wider in comparison with the rest of the hydrophilic channel 101 to enable the liquid sample to be easily deposited, but it needs not be the case; in other embodiments, the inlet 102 may be the same width as the rest of the hydrophilic channel 101. When the liquid sample is deposited onto the inlet 102, the hydrophilic channel 101 passively, through diffusion, transports the liquid sample along its length towards the sensing area, on which a plurality of electrochemical sensing electrodes 103a, 104a, 105a is disposed.

In the present embodiment, the plurality of electrochemical sensing electrodes 103a, 104a, 105a comprises a working electrode (WE) 103a, a reference electrode (RE) 104a, and a counter electrode (CE) 105a. Inorganic catalyst materials (e.g. copper oxide nanoparticles) are deposited, e.g. from a solution by drop-casting or printing and left to dry, on the WE surface to functionalise the WE. The sensing electrodes 103a, 104a, 105a are formed into conductive tracks plated by an inert metal (e.g. gold). The conductive tracks enable good current transduction, e.g. towards instrumentation electrically connected to the electrodes, and the inert metal plating reduces undesirable chemical reactions between the electrodes and the liquid sample. In some embodiments, in addition to the inert metal plating, the inorganic catalyst may be further encapsulated by a suitable material if desired for improved stability and/or signal amplification. Each of the conductive tracks forming each of WE 103a, RE 104a and CE 105a extends towards an edge of the device 100 into a respective connection pad 103b, 104b, 105b arranged to electrically interface with e.g. an electronic reader 120 via a suitable connection (e.g. an electrical cable) 110. When the device 100 is in use, an electrical potential is applied between the WE 103a and the RE 104a (e.g. through the connection pads 103b and 104b by the electronic reader 120), and the resulting current is read via the CE 105a, e.g. by the electronic reader 120 through connection pad 105b.

In the present embodiment, the device 100 is further provided with a pH control system, comprising, in this example, a set of pH control electrodes 106a, 107a, disposed on the substrate 109 at the same end as the plurality of electrodes 103a, 104a, 105a adjacent to the WE 103a. The set of pH control electrodes comprises a pH sensing electrode (PHSE) 106a and an active pH control electrode (PHCE) 107a, respectively extends into connection pads 106b and 107b arranged to electrically interface with the electronic reader 120.

The PHSE 106a can be any suitable commercially available ion selective sensing device as desired. For example, the PHSE 106a may be an ion-sensitive field-effect transistor (ISFET) or an ion-sensitive extended gate field-effect transistor, such as ITO, ZnO, parylene or the like. The PHCE 107a may e.g. be a quinone functionalized electrode for electrochemically inducing the release of electrons or protons in locality of the electrode. The PHCE 107a may alternatively be configured to function as a controlled release valve for a source of alkaline (e.g. NaOH) stored on-chip.

In the present embodiment, the PHSE 106a and the PHCE 107a are controlled by the electronic reader having implemented thereon a predetermined senor pH calibration algorithm. The sensor pH calibration algorithm defines an operation pH value (or operation pH value range) that is appropriate for the chemical reaction between the analyte in the liquid sample and the inorganic catalyst on the WE 103a, and defines instructions for controlling the PHCE 107a based on pH values measured at the PHSE 106a so as to achieve the desired pH value or range of pH values. Thus, based on the pH value read at the PHSE 106a and the specific properties of the non-enzymatic inorganic catalyst on the WE 103a, the present device 100 enables the electronically tuneable sensing of different analytes, by algorithmically adapting the sensitivity and selectivity of the WE 103a through adjusting the pH value of the sample liquid in the region around the WE 103a.

The hydrophilic channel 101 may be formed by paper in a hybrid implementation, or via photolithography in dry film photoresists in a seamless integration implementation. In the latter case, a hydrophilization process may be performed after the formation, comprising for example oxygen plasma treatment of a micropatterned interior.

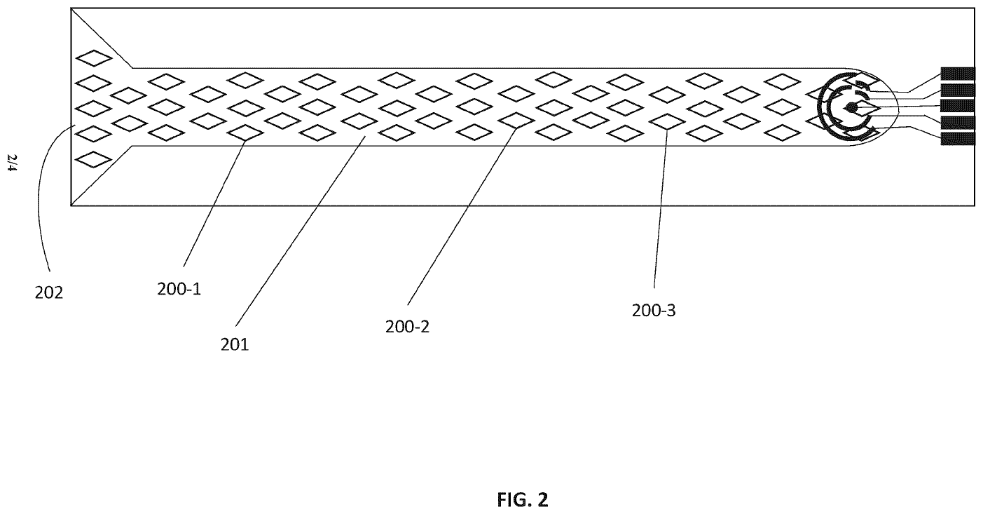

An exemplary micropatterned hydrophilic channel 201 is shown in FIG. 2. In the present embodiment, the diamond shaped micropatterns 200-1, 200-2, 200-3 facilitate the passive (i.e. without application of external pressure) flow of a liquid sample from inlet 202 towards to the sensing area towards an opposite end of the channel 201. Micropatterns of shapes other than the present diamond shape, including a same shape or a combination of two or more shapes, are of course possible as desired.

In different embodiments, the dimensions of the hydrophilic channel (e.g. the hydrophilic channel 101) may range from 250pm in width to 1 mm, as desired and defined by manufacturing limitations. The length and thickness of the hydrophilic channel may be determined by the sample volume of the intended liquid sample that needs to be accommodated by the hydrophilic channel for analysis and quantification to take place, and the sample volume may be defined by the clinical concentration range of the target analyte in the liquid sample and molecule diffusion time of the analyte towards the working electrode area.

In an implementation example, copper oxide, e.g. in the form of nanoparticles, is used as an inorganic alternative to glucose oxidase enzyme in glucose analysis, owing to its sensitivity in lower analyte (glucose) concentrations and improved specificity. However, the potential of copper oxide as an alternative catalyst has not been adopted in practice due to a technical requirement for a precise control of the acidity/basicity of the liquid sample local to the WE on which it is deposited. In the case of glucose analysis via blood sample, blood serum pH is mostly stable around the physiological range (7.4), and as such, active pH control is not required. However, human saliva pH can vary greatly from person to person as well as over a period of time for the same person depending on food or drink intake and oral health, and the variation in pH introduces inaccuracy or uncertainty in glucose analysis performed on saliva sample when copper oxide is used. In such a case, a pH control system, such as the pH control system comprising PHSE 106a and PHCE 107a, may be implemented on embodiments of the present invention to measure and active control the acidity/basicity of the liquid sample adjacent the WE 103a.

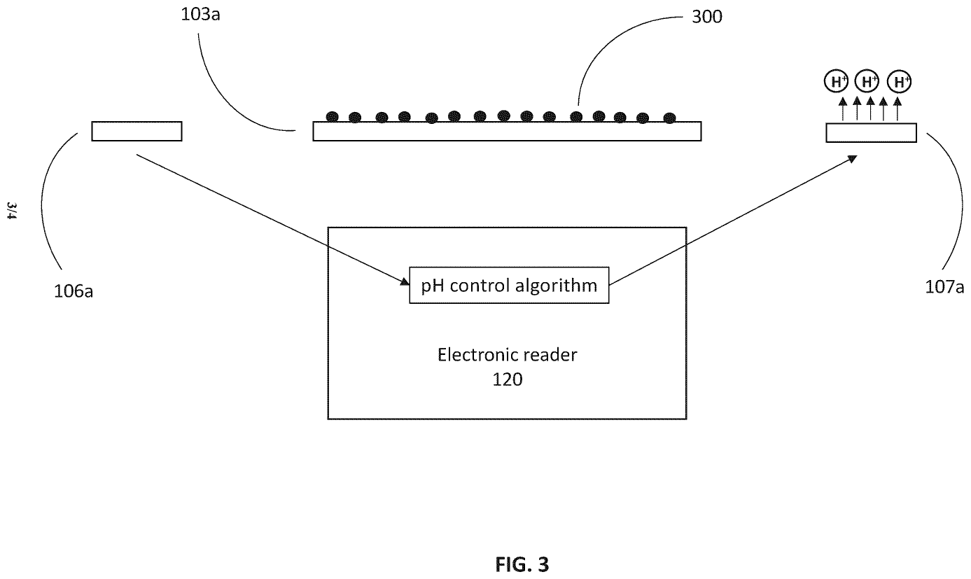

FIG. 3 shows the sensing area of the device 100 as viewed side on, illustrating a pH control mechanism performed by the PHSE 106a and PHCE 107a, controlled through the electronic reader 120 by a pH control algorithm. As described above, the WE 103a disposed between the PHSE 106a and the PHCE 107a is functionalized with an inorganic catalyst that enables chemical reaction with a target analyte (e.g. glucose molecules). In the present embodiment, the inorganic catalyst may be copper oxide (CuO) nanoparticles 300. In use, the PHSE 106a enables an electronic reading of the liquid sample pH value to be taken by the external electronic reader 120. The electronic reader 120 implements a pH control algorithm that defines instructions for providing an electronic signal stimulus (e.g. a voltage or a current) to the PHCE 107a. The magnitude of the electronic signal stimulus is determined by (e.g. proportional to) the pH value measured at the PHSE 106a, and the electronic signal stimulus causes the PHCE 107a to release protons to the locality of WE 103a, thus locally adjusting the acidity/basicity to a predetermined level (e.g. a predetermined pH value).

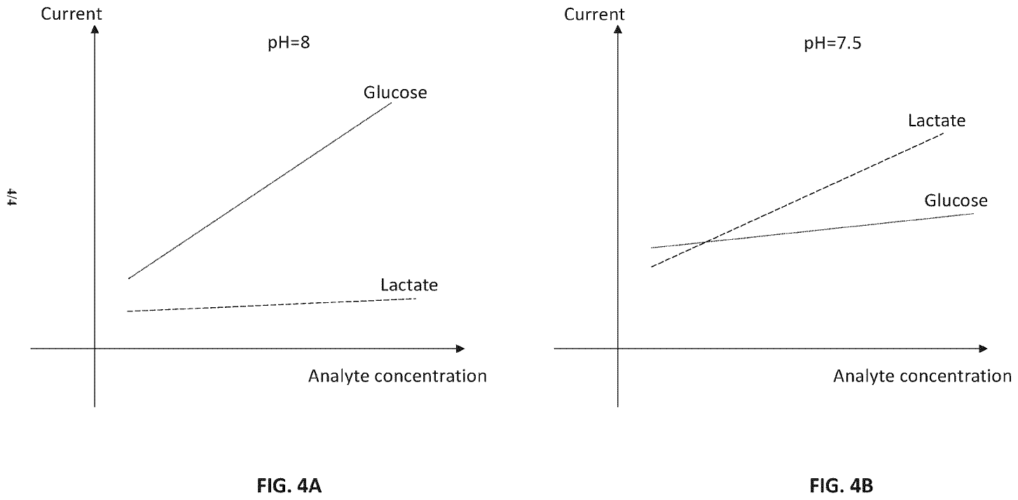

FIG. 4A and FIG. 4B illustrate the specificity of copper oxide to glucose and lactate at different acidity/basicity. As shown in FIG. 4A, when the solution pH value is tuned at 8, copper oxide can be used as an inorganic catalyst in an electrochemical sensing device described above to accurately quantifies glucose. On the other hand, as shown in FIG. 413, when the solution pH value is tuned at 7.5, a device as described above can accurately quantify lactate.

The examples and conditional language recited herein are intended to aid the reader in understanding the principles of the present invention and not to limit its scope to such specifically recited examples and conditions. It will be appreciated that those skilled in the art may devise various arrangements which, although not explicitly described or shown herein, nonetheless embody the principles of the present invention and are included within its scope as defined by the appended claims.

Furthermore, as an aid to understanding, the above description may describe relatively simplified implementations of the present invention. As persons skilled in the art would understand, various implementations of the present invention may be of a greater complexity.

In some cases, what are believed to be helpful examples of modifications to the present invention may also be set forth. This is done merely as an aid to understanding, and not to limit the scope or set forth the bounds of the present invention. These modifications are not an exhaustive list, and a person skilled in the art may make other modifications while nonetheless remaining within the scope of the present invention. Further, where no examples of modifications have been set forth, it should not be interpreted that no modifications are possible and/or that what is described is the sole manner of implementing that element of the present invention.

Moreover, all statements herein reciting principles, aspects, and implementations of the invention, as well as specific examples thereof, are intended to encompass both structural and functional equivalents thereof, whether they are currently known or developed in the future.

It will be clear to one skilled in the art that many improvements and modifications can be made to the foregoing exemplary embodiments without departing from the scope of the present invention. Changes and modifications in the specifically-described embodiments may be carried out without departing from the principles of the present invention, which is intended to be limited only by the scope of the appended claims as interpreted according to the principles of patent law including the doctrine of equivalents.

1. An electrochemical sensing device for quantifying an analyte in a liquid sample, the device comprising:
a substrate;
a plurality of electrodes disposed on the substrate, one of the plurality of electrodes being functionalised with a catalyst, the catalyst comprising an inorganic compound;
a pH control system disposed adjacent the plurality of electrodes configured to control an acidity or basicity of at least a region around the functionalised electrode, the pH control system comprising a pH sensing electrode and an active pH control electrode;
an alkaline source stored on the device; and
a hydrophilic channel disposed on the substrate configured to receive the liquid sample and direct the liquid sample to the electrodes;
wherein the active pH control electrode is configured to function as a controlled release valve for the alkaline source stored on the device.

2. The device of claim 1, wherein the inorganic compound comprises a metal oxide including one or more of copper oxide, cobalt oxide, nickel oxide, iron oxide, or zinc oxide.

3. The device of claim 1, wherein the plurality of electrodes comprises at least a working electrode, a counter electrode and a reference electrode, and wherein the pH control system is disposed adjacent the working electrode.

4. The device of claim 1, wherein the pH sensing electrode comprises an ion selective sensing device or an ion-sensitive extended gate electrode arranged to enable an electronic reading of a pH value to be measured.

5. The device of claim 1, wherein the pH control system is configured to communicate with and controlled by an electronic reader implementing a predetermined pH calibration algorithm.

6. The device of claim 1, wherein each of the plurality of electrodes extends into an electrical connection pad configured to interface with an electronic reader.

7. The device of claim 1, wherein the plurality of electrodes comprises at least a working electrode, a counter electrode and a reference electrode, wherein the plurality of electrodes is arranged such that, upon applying an electrical potential between the working electrode and the reference electrode, a current is measured via the counter electrode.

8. The device of claim 7, wherein the functionalised electrode is the working electrode and the catalyst is deposited thereon.

9. The device of claim 8, wherein the hydrophilic channel is formed of paper.

10. The device of claim 8, wherein the hydrophilic channel is formed of dry film photoresist.

11. The device of claim 8, wherein the hydrophilic channel is formed with a surface micropattern configured to facilitate diffusion of the liquid sample.

12. The device of claim 1, wherein the substrate comprises a printed circuit board.

13-17. (canceled)
